(19) United States
(12) Patent Application Publication
(10) Pub. No.: US 2020/0314300 A1
(43) Pub. Date: Oct. 1, 2020

(54) LENS MODULE

(71) Applicant: HON HAI PRECISION INDUSTRY CO., LTD., New Taipei (TW)

(72) Inventors: YA-LAN FENG, New Taipei (TW); CHUN-CHENG KO, New Taipei (TW)

(21) Appl. No.: 16/743,190

(22) Filed: Jan. 15, 2020

(30) Foreign Application Priority Data
Mar. 29, 2019 (CN) 201910248379.0

(51) Int. Cl. H04N 5/225; B29D 11/00; G02B 1/12; G02B 1/11

(52) U.S. Cl. CPC H04N 5/2254; B29D 11/0048; G02B 7/10; G02B 1/11; G02B 1/12

(57) ABSTRACT

A lens module includes a lens barrel and a lens group located within the lens barrel. The lens barrel defines a receiving cavity and a light hole. The receiving cavity receives the lens group. The lens barrel includes a protrusion protruding from an inner wall of the receiving cavity adjacent to the light hole. An inner surface of the protrusion facing the lens group is a rough surface.

### FIELD

The subject matter herein generally relates to lens modules, and more particularly to a lens module applicable in an electronic device.

### BACKGROUND

Generally, when a lens module captures an image under strong light conditions, light at a specific angle will enter the lens module and reflect into an image sensor of the lens module, which causes glare and affects an image quality.

### BRIEF DESCRIPTION OF THE DRAWINGS

Implementations of the present disclosure will now be described, by way of embodiments, with reference to the attached figures.

FIG. 1 is an assembled, isometric view of an embodiment of a lens module.

FIG. 2 is an exploded, isometric view of the lens module in FIG. 1.

FIG. 3 is a cross-sectional view taken along line in FIG. 1.

FIG. 4 is a flowchart of a method for manufacturing a lens barrel of the lens module.

FIG. 5A is a photo of an inner surface of a protrusion of the lens barrel sandblasted by 180-mesh particles.

FIG. 5B is a photo taken by the lens module using the lens barrel in FIG. 5A.

FIG. 6A is a photo of an inner surface of a protrusion of the lens barrel sandblasted by 100-mesh particles.

FIG. 6B is a photo taken by the lens module using the lens barrel in FIG. 6A.

FIG. 7A is a photo of an inner surface of a protrusion of the lens barrel sandblasted by a mixture of 180-mesh particles and 100-mesh particles.

FIG. 7B is a photo taken by the lens module using the lens barrel in FIG. 7A.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like.

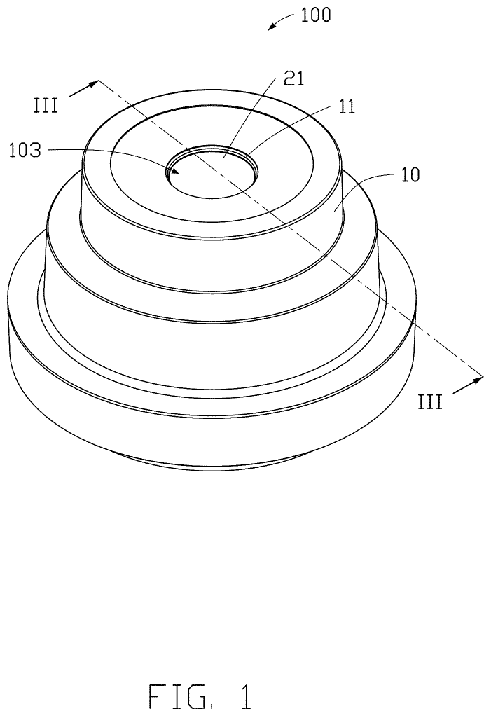

FIG. 1 shows an embodiment of a lens module 100 applicable in an electronic device, such as a mobile phone, a tablet computer, a notebook computer, or the like.

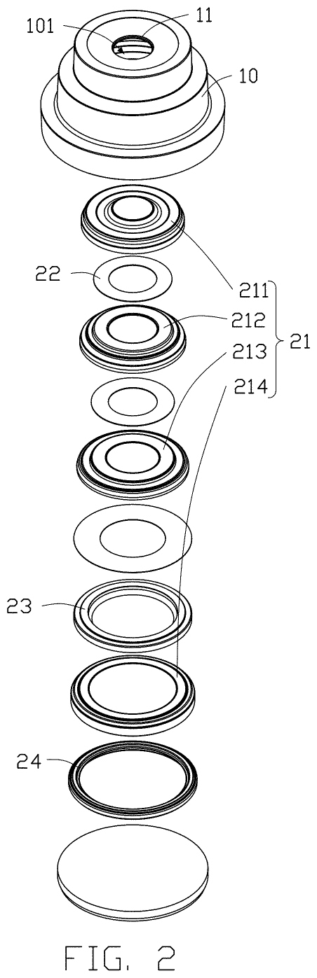

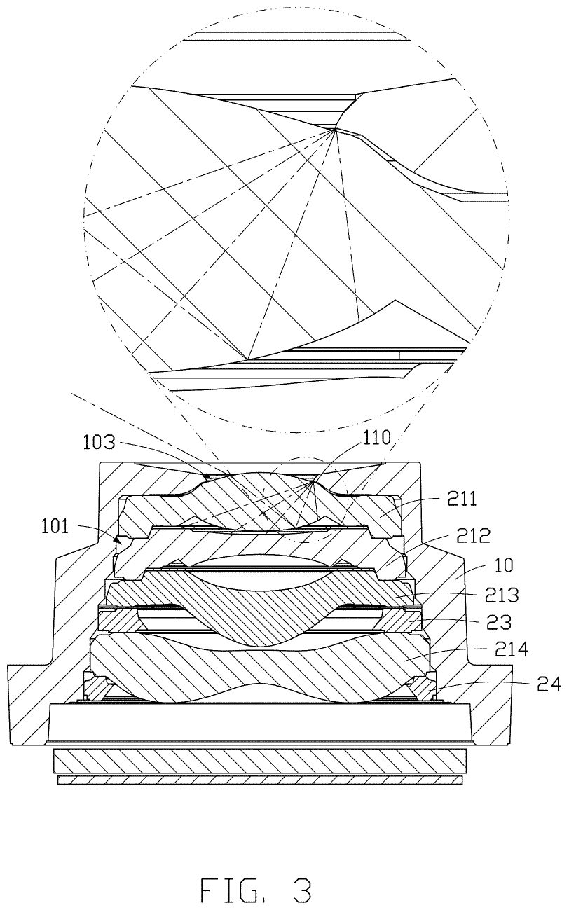

Referring to FIG. 2 and FIG. 3, the lens module 100 includes a lens barrel 10, a lens group 21, a plurality of somas 22, a spacer 23, a retainer 24, a filter 25, and an image sensor 26. The lens group 21, the somas 22, the spacer 23, the retainer 24, the filter 25, and the image sensor 26 are located within the lens barrel 10.

The lens barrel 10 defines a receiving cavity 101 and a light hole 103. The receiving cavity 101 receives the lens group 21, the somas 22, the spacer 23, the retainer 24, the filter 25, and the image sensor 26. The light hole 103 is defined in a top wall of the lens barrel 10 and communicates with the receiving cavity 101.

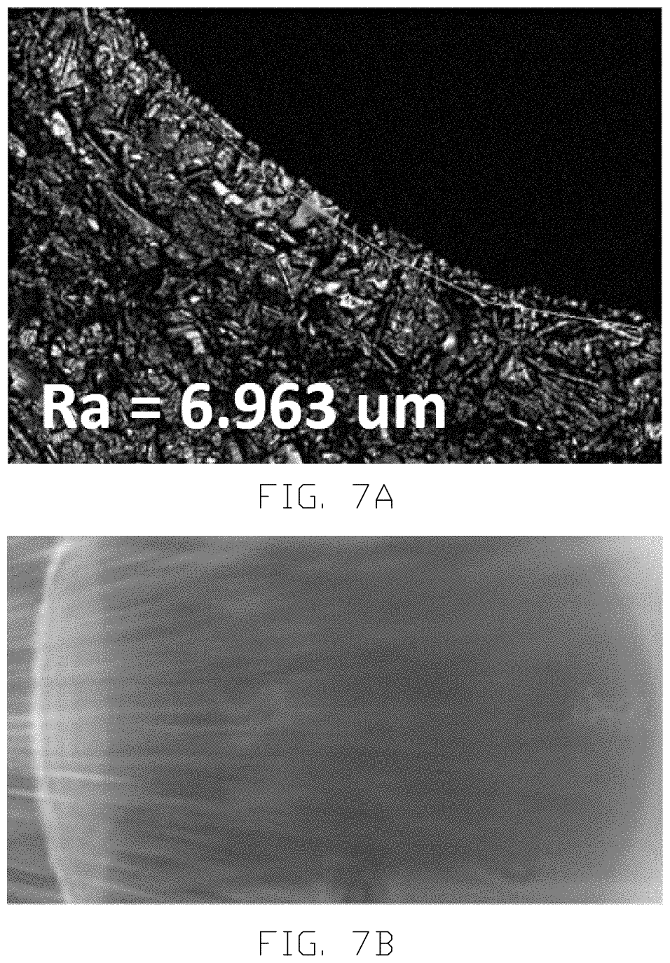

The lens barrel 10 includes an annular protrusion 11 protruding from an inner wall of the light hole 103 to block light. As shown in FIG. 7A, an inner surface 110 of the protrusion 11 facing the lens group 21 is a rough surface capable of scattering light reflected by the lens group 21, thereby reducing glare and improving imaging quality.

In one embodiment, a he surface roughness Ra of the inner surface 110 is 6.963 microns. It can be understood that, in other embodiments, the surface roughness Ra of the inner surface 110 may be greater than 6 microns.

It can be understood that, in other embodiments, an inner wall of the receiving cavity 101 may be a rough surface.

The lens group 21 includes a first lens 211, a second lens 212, a third lens 213, and a fourth lens 214 sequentially stacked from an object side to an image side of the lens module 100. Each of the plurality of somas 22 may be located between any two adjacent lenses of the lens group 21.

It can be understood that, in other embodiments, the lens group 21 may include different numbers of lenses.

The spacer 23 is located between peripheral edge portions of the third lens 213 and the fourth lens 214 to maintain a predetermined interval between the third lens 213 and the fourth lens 214.

The retainer 24 is adhered to a side of the fourth lens 214 facing the image side for supporting and fixing the lens group 21 and blocking light.

FIG. 7B is a photo taken by the lens module 100. It can be seen that the roughness of the inner surface 110 can effectively reduce glare.

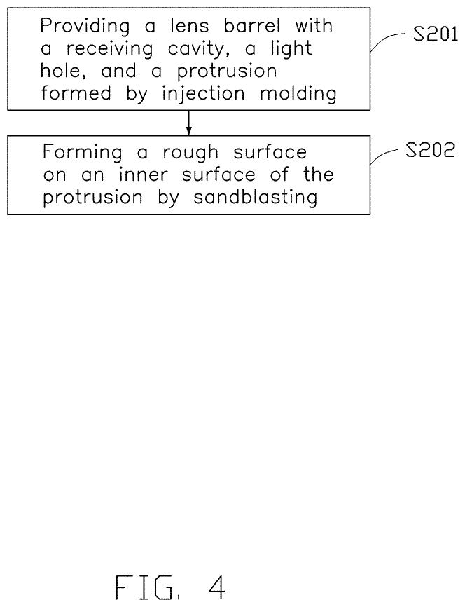

Referring to FIG. 4, a method for manufacturing the lens barrel 10 may include the following blocks:

S201: The lens barrel 10 provided with the receiving cavity 101 and the light hole 103 is formed by injection molding. The lens barrel 10 is provided with the annular protrusion 11 for blocking light.

S202: A rough surface is formed on the inner surface 110 of the protrusion by sandblasting.

In general, a rougher surface can increase a range of light reflections, thereby reducing stray light entering the image sensor. Therefore, a larger diameter grit particle is used for sand blasting. However, if a diameter of the particles is too large, a density of the particles is reduced, so that the surface to be blasted has a plane that is not blasted.

In one embodiment, a length of the inner surface 110 parallel to an optical axis is 0.16 mm.

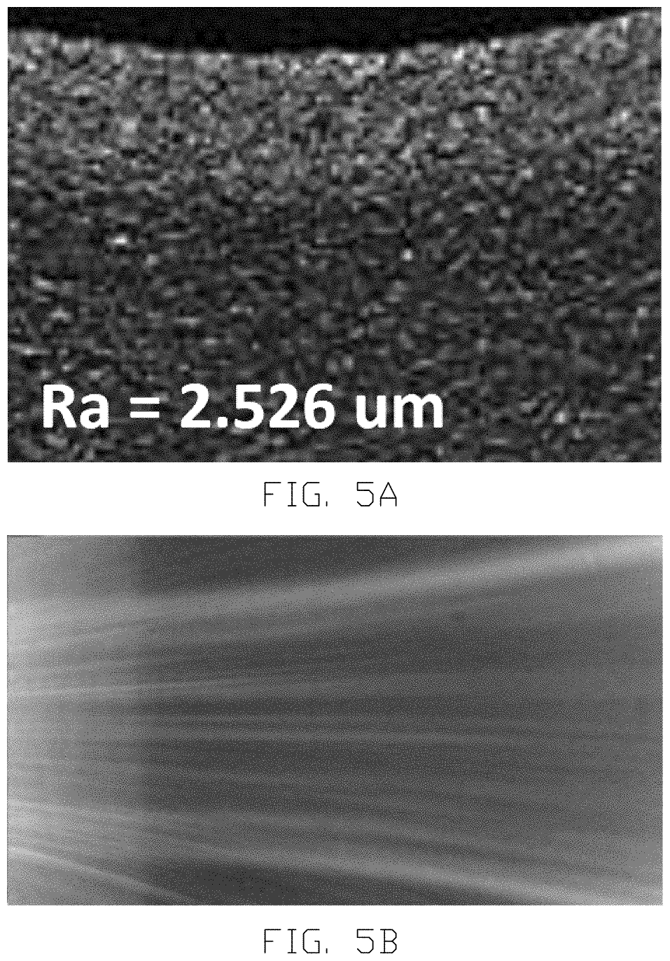

Referring to FIGS. 5A-5B, when 180-mesh particles are used for sandblasting, the surface roughness Ra of the inner surface 110 is 2.526 microns, and glare still exists in the photo.

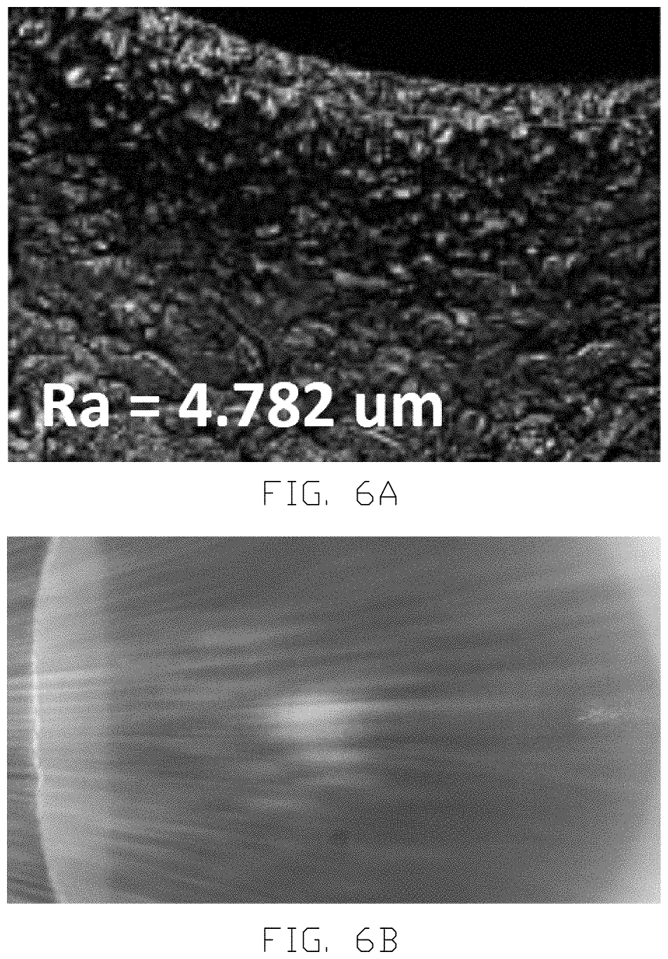

Referring to FIGS. 6A-6B, when 100-mesh particles are used for sandblasting, the surface roughness Ra of the inner surface 110 is 4.782 microns. However, a portion of the inner surface 110 is not covered by the particles, and glare still exists in a middle portion of the photo.

Referring to FIGS. 7A-7B, in the present disclosure, the 180-mesh particles and the 100-mesh particles are mixed and then used for sandblasting to achieve a higher surface roughness and blasting density, thereby achieving a better scattering effect of light. After blasting with the 180-mesh and 100-mesh particles, the surface roughness Ra of the inner surface 110 is 6.963 microns.

It can be understood that, in other embodiments, particles of other sizes may be mixed for sandblasting, and a plurality of particles of different sizes may be mixed for sandblasting.

It can be understood that, in other embodiments, the inner wall of the receiving cavity 101 may also be blasted together with the inner surface 110.

In the present disclosure, a rough surface is formed on the inner surface 110 to scatter light reflected thereon, thereby reducing glare and improving an image quality.

Further, in the sandblasting step, particles of at least two different sizes are mixed for blasting, thereby providing surface roughness and blasting density at the same time to achieve a good blasting effect.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A lens barrel defining a receiving cavity and a light hole, the receiving cavity receiving a lens group, the lens barrel comprising:
a protrusion protruding from an inner wall of the receiving cavity adjacent to the light hole; wherein:
an inner surface of the protrusion facing the lens group is a rough surface.

2. The lens barrel of claim 1, wherein:
an inner wall of the receiving cavity is a rough surface.

3. The lens barrel of claim 1, wherein:
a surface roughness of the inner surface of the protrusion is greater than 6 microns.

4. A lens module comprising:
a lens barrel;
a lens group located within the lens barrel; wherein:
the lens barrel defines a receiving cavity and a light hole;
the receiving cavity receives the lens group;
the lens barrel comprises a protrusion protruding from an inner wall of the receiving cavity adjacent to the light hole; and
an inner surface of the protrusion facing the lens group is a rough surface.

5. The lens module of claim 4, wherein:
an inner wall of the receiving cavity is a rough surface.

6. The lens module of claim 4, wherein:
a surface roughness of the inner surface of the protrusion is greater than 6 microns.

7. The lens module of claim 6, further comprising a plurality of somas, wherein:
each of the plurality of somas is located between two adjacent lenses of the lens group.

8. A method of manufacturing a lens barrel of a lens module, the method comprising:
forming, by injection molding, the lens barrel defining a receiving cavity and a light hole, the lens barrel comprising an annular protrusion protruding from an inner wall of the receiving cavity adjacent to the light hole; and
sandblasting an inner surface of the protrusion facing the receiving cavity to form a rough surface on the inner surface.

9. The method of claim 8, wherein:
particles of at least two different sizes are mixed for sandblasting.

10. The method of claim 9, wherein:
180-mesh particles and 100-mesh particles are mixed and then used for sandblasting.

11. The method of claim 8, wherein:
an inner wall of the receiving cavity is sandblasted.
